(19) United States
(12) Patent Application Publication
(10) Pub. No.: US 2026/0125564 A1
(43) Pub. Date: May 7, 2026

(54) CURABLE RESIN COMPOSITION FOR STEREOLITHOGRAPHY, CURED PRODUCT, AND THREE-DIMENSIONAL SHAPED OBJECT

(71) Applicant: DIC Corporation, Tokyo (JP)

(72) Inventors: Shoko Nishida, Chiba (JP); Takashi Nishijima, Chiba (JP); Yoshinobu Deguchi, Chiba (JP); Takayuki Miki, Chiba (JP)

(73) Assignee: DIC Corporation, Tokyo (JP)

(21) Appl. No.: 19/381,620

(22) Filed: Nov. 6, 2025

(30) Foreign Application Priority Data
Nov. 7, 2024 (JP) 2024-195103

(51) Int. Cl. C09D 4/06; B33Y 80/00; C09D 133/08; C09D 135/02; C09D 175/16

(52) U.S. Cl. CPC C09D 4/06; B33Y 80/00; C09D 133/08; C09D 135/02; C09D 175/16

(57) ABSTRACT

A curable resin composition for stereolithography capable of forming an optical three-dimensional shaped object having both sufficient toughness and heat resistance, a cured product of the composition, and a three-dimensional shaped object are provided. The curable resin composition contains a urethane resin (A) having two (meth)acryloyl groups, an α,β-unsaturated carbonyl compound (B), and a photopolymerization initiator. The urethane resin (A) is obtained by using, as reaction raw materials a polycarbonate diol (a1), a diisocyanate (a2), and a compound (a3) having a hydroxyl group and a (meth)acryloyl group. The polycarbonate diol (a1) has a branched or linear aliphatic structure. The α,β-unsaturated carbonyl compound (B) has a glass transition temperature (Tg) of 50° C. or higher when formed into a polymer. The urethane resin (A) has a number average molecular weight (Mn) of 2000 or more.

### TECHNICAL FIELD

The present invention relates to a curable resin composition for stereolithography, a cured product, and a three-dimensional shaped object.

### BACKGROUND ART

In recent years, as a method for producing a resin molded article, an optical three-dimensional shaping method (stereolithography) has been used in which a three-dimensional shaped object is fabricated by selectively polymerizing and curing a curable resin composition with an active energy ray such as an ultraviolet laser based on three-dimensional shape data designed by a three-dimensional design system such as a three-dimensional CAD. The optical three-dimensional shaping method can cope with a complicated shape which is difficult to be formed by cutting, and is short in manufacturing time and easy to handle, and therefore, has come to be widely used for manufacturing a prototype model of an industrial product in addition to a resin molded article.

A typical example of the optical three-dimensional shaping method includes a method of obtaining a three-dimensional shaped object by repeating the following operations: irradiating a liquid photocurable resin put in a container with a spot-shaped ultraviolet laser controlled by a computer from above to cure one layer having a predetermined thickness; lowering the shaped object by one layer to supply the liquid resin on the layer; similarly irradiating the resin with an ultraviolet laser beam to cure the resin; and laminating the cured resin. In addition to the above-described stippling method using a spot-shaped ultraviolet laser, the number of surface exposure methods has been recently increased in which a light source other than a laser such as an LED is used, ultraviolet light is emitted from below through a transparent container containing a photocurable resin via a planar drawing mask called a digital micromirror device (DMD) in which a plurality of digital micromirror shutters are arranged in a planar shape to cure one layer of a predetermined cross-sectional shape pattern, the shaped object is pulled up by one layer, the next layer is irradiated and cured in the same manner as described above, and the layers are sequentially laminated to obtain a three-dimensional shaped object.

The above-described optical three-dimensional shaping method (stereolithography) has been actively developed because of its high shaping speed and high accuracy (see, for example, Patent Documents 1 and 2). As a result, along with improvement of stereolithography machines and stereolithography materials, an application range of the stereolithography is expanding from a prototype to a final product. However, in the case of automobile parts, household electrical appliance parts, and the like, an optical three-dimensional shaped object having both sufficient toughness and heat resistance as a final product has not been obtained by the existing techniques.

Therefore, a curable resin composition for stereolithography capable of forming an optical three-dimensional shaped object having both sufficient toughness and heat resistance has been required.

### CITATION LIST

### Patent Documents

Patent Document 1: JP 2019-199448 A
Patent Document 2: WO 2022/209689

### SUMMARY OF INVENTION

### Technical Problem

An object of the present invention is to provide a curable resin composition for stereolithography capable of forming an optical three-dimensional shaped object having both sufficient toughness and heat resistance, a cured product thereof, and a three-dimensional shaped object.

### Solution to Problem

The present invention encompasses the following aspects.

[1]A curable resin composition for stereolithography, containing:
a urethane resin (A) having two (meth)acryloyl groups;
an α,β-unsaturated carbonyl compound (B); and
a photopolymerization initiator, wherein the urethane resin (A) is obtained by using, as reaction raw materials, a polycarbonate diol (a1), a diisocyanate (a2), and a compound (a3) having a hydroxyl group and a (meth)acryloyl group,
the polycarbonate diol (a1) has a branched or linear aliphatic structure, the α,β-unsaturated carbonyl compound (B) has a glass transition temperature (Tg) of 50° C. or higher when formed into a polymer, and
the urethane resin (A) has a number average molecular weight (Mn) of 2000 or more.

[2] The curable resin composition for stereolithography according to [1], further containing a compound (C) having two or more (meth)acryloyl groups,
wherein
the compound (C) having two or more (meth)acryloyl groups has a glass transition temperature (Tg) of 60° C. or higher when formed into a polymer.

[3] The curable resin composition for stereolithography according to [1] or [2], wherein the α,β-unsaturated carbonyl compound (B) is a compound having one (meth)acryloyl group.

[4] The curable resin composition for stereolithography according to any of [1] to [3], wherein a content of the (meth)acryloyl groups in the urethane resin (A) is 0.3 mmol/g or more and 2.0 mmol/g or less.

[5] The curable resin composition for stereolithography according to any of [1] to [4], wherein a content of the urethane resin (A) is 1 mass % or more and 50 mass % or less.

[6] The curable resin composition for stereolithography according to any of [1] to [5], wherein a content of the α,β-unsaturated carbonyl compound (B) is 20 mass % or more and 90 mass % or less.

[7] The curable resin composition for stereolithography according to any of [2] to [5], wherein a content of the compound (C) having two or more (meth)acryloyl groups, when the compound (C) is contained, is 1 mass % or more and 50 mass % or less.

[8] The curable resin composition for stereolithography according to any of [1] to [7], wherein the urethane resin (A) is a resin represented by Formula (1) described below:

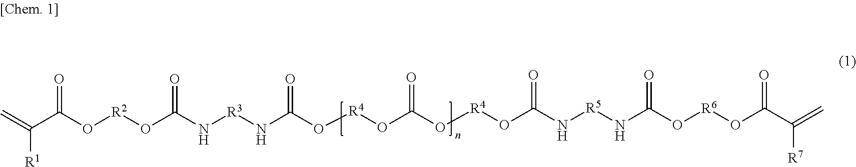

(in Formula (1),
R¹ and R⁷ each independently represent a hydrogen atom or a methyl group, R² and R⁶ each independently represent —C₂H₄—, —C₃H₆—, —C₄H₈—, or —C₂H₄O(COC₅H₁₀)ₛ— (s=from 1 to 4),
R³ and R⁵ each independently represent —C₅H₁₀—, —C₆H₁₂—, —C₁₀H₁₈—, or —C₉H₁₈—,
R⁴ represents one or two or more divalent groups selected from the group consisting of —(CH₂)ₛ— (s=from 2 to 12) and —(CH₂)ₛ—CH(CH₃)—(CH₂)ₜ— (s and t are optionally 0, and s+t=from 0 to 10), and
n represents an integer of from 2 to 100.

[9]A cured product which is a cured reaction product of the curable resin composition for stereolithography described in any of [1] to [8].

[10]A three-dimensional shaped object including the cured product described in [9].

### Advantageous Effects of Invention

According to the present invention, it is possible to provide a curable resin composition for stereolithography capable of forming an optical three-dimensional shaped object having both sufficient toughness and heat resistance, a cured product thereof, and a three-dimensional shaped object.

### DESCRIPTION OF EMBODIMENTS

Curable Resin Composition for Stereolithography A curable resin composition for stereolithography according to an embodiment of the present invention contains a urethane resin (A) having two (meth)acryloyl groups (hereinafter sometimes simply referred to as “urethane resin (A)”), an α,β-unsaturated carbonyl compound (B), and a photopolymerization initiator. The urethane resin (A) is obtained by using a polycarbonate diol (a1), a diisocyanate (a2), and a compound (a3) having a hydroxyl group and a (meth)acryloyl group as reaction raw materials. The polycarbonate diol (a1) has a branched or linear aliphatic structure. The urethane resin (A) has a number average molecular weight (Mn) of 2000 or more.

The α,β-unsaturated carbonyl compound (B) has a glass transition temperature (Tg) of 50° C. or higher when formed into a polymer. The α,β-unsaturated carbonyl compound (B) is preferably a compound (Bac) having one (meth)acryloyl group.

The curable resin composition for stereolithography of the present embodiment preferably further contains a compound (C) having two or more (meth)acryloyl groups. The compound (C) having two or more (meth)acryloyl groups has a glass transition temperature (Tg) of 60° C. or higher when formed into a polymer.

A content of the (meth)acryloyl groups in the urethane resin (A) is preferably 0.3 mmol/g or more and 2.0 mmol/g or less.

The curable resin composition for stereolithography of the present embodiment may also contain an additional trifunctional or higher functional (meth)acrylic compound other than the α,β-unsaturated carbonyl compound (B) and/or the compound (C) having two or more (meth)acryloyl groups, as long as the effects of the present invention are not inhibited.

Further, the curable resin composition for stereolithography of the present embodiment may also contain an additional additive such as a photosensitizer, an ultraviolet absorber, a polymerization inhibitor, or an inorganic filler, as necessary.

### Urethane Resin (A)

The urethane resin (A) used in the present embodiment can be obtained by reacting the polycarbonate diol (a1), the diisocyanate (a2), and the compound (a3) having a hydroxyl group and a (meth)acryloyl group.

### Polycarbonate Diol (a1)

The polycarbonate diol (a1) has a branched or linear aliphatic structure. The branched or linear aliphatic structure is, for example, preferably a branched or linear aliphatic structure having from 2 to 12 carbon atoms, more preferably a branched or linear aliphatic structure having from 3 to 10 carbon atoms, and still more preferably a branched or linear aliphatic structure having from 3 to 9 carbon atoms.

Examples of the linear aliphatic structure having from 2 to 12 carbon atoms include —(CH₂)ₛ— (s=from 2 to 12).

Examples of the branched aliphatic structure having from 2 to 12 carbon atoms include —(CH₂)ₛ—CH(CH₃)—(CH₂)ₜ— (s and t may be 0, and s+t=from 0 to 10), and —(CH₂)ₛ—CH(C₂H₄)—(CH₂)ₜ— (s and t may be 0, and s+t=from 0 to 9).

Examples of the branched aliphatic structure having from 2 to 12 carbon atoms include a skeleton of isosorbide, a skeleton of cyclohexanedimethanol, a skeleton of 3-methylpentanediol (3MPD), and a skeleton of 2-methyloctanediol (MOD).

In the present specification, the “skeleton of diol” is a structure of diol after the —OH group is removed.

The polycarbonate diol (a1) is preferably a diol represented by the Formula (2).

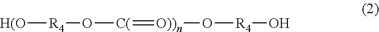

In Formula (2),
R₄ may be one type or two or more types, and at least one substituent is a branched or linear aliphatic alkylene group. R₄ may be one type or two or more types, and may be an aliphatic, alicyclic, or aliphatic/alicyclic alkylene group. The number of carbon atoms of the at least one branched or linear aliphatic alkylene group in the R₄ is from 2 to 12, preferably from 4 to 10. The number of carbon atoms is more preferably from 4 to 9.
n is an integer of from 2 to 100.
R₄ may be one type or two or more types, and at least one thereof is —CH₂CH₂CH(CH₃)CH₂CH₂—, —(CH₂)₆—, or —(CH₂)₄—, preferably a combination of —CH₂CH₂CH(CH₃)CH₂CH₂— and —(CH₂)₆—.

A number average molecular weight (Mn) of the polycarbonate diol (a1) is not particularly limited as long as the number average molecular weight (Mn) of the urethane resin (A) of the present embodiment falls within the range of the number average molecular weight (Mn) of the urethane resin (A) in accordance with a structure derived from the diisocyanate (a2) described below, a structure derived from the compound (a3) having a hydroxyl group and a (meth)acryloyl group, and, if necessary, a structure derived from the compound (C) having two or more (meth)acryloyl groups. For example, the number average molecular weight (Mn) of the polycarbonate diol (a1) may be 1200 or more, may be 1500 or more, or may be 2000 or more. The larger the number average molecular weight, the longer a distance between crosslinking points, and the more impact resistance is improved. On the other hand, viscosity becomes high and shaping accuracy becomes poor. Therefore, the number average molecular weight may be 10000 or less, or may be 8000 or less.

Specific examples of the polycarbonate diol (a1) include, but are not limited to, those commercially available from Kuraray Co., Ltd. under the trade name “Kuraray Polyol”. Among them, for example, C-2050, C-3050, C-3090, C-2015N, C-2065N, and the like, which include a branched aliphatic structure, are specifically indicated. Further, G3452 which includes a linear aliphatic structure is indicated.

A content of a skeleton of the polycarbonate diol (a1) in the urethane resin (A) may be 10 mass % or more, 20 mass % or more, or 30 mass % or more. The content may be 90 mass % or less, 80 mass % or less, or 70 mass % or less. For example, a content of the polycarbonate diol (a1) may be 10 parts by mass or more, 20 parts by mass or more, or 30 parts by mass or more, with respect to 100 parts by mass of a total mass of raw materials for synthesizing the urethane resin (A). The content may be 90 parts by mass or less, 80 parts by mass or less, or 70 parts by mass or less.

In the present specification, the “skeleton of the polycarbonate diol (a1)” is a structure of the polycarbonate diol (a1) after the —OH group is removed.

### Diisocyanate (a2)

The diisocyanate (a2) may be any organic isocyanate having two free isocyanate groups. Examples of the organic isocyanate include aliphatic, alicyclic, aromatic, and araliphatic isocyanates.

The diisocyanate (a2) is not particularly limited as long as the urethane resin (A) of the present embodiment can be formed, and may be appropriately selected depending on the intended purpose. Examples of the diisocyanate (a2) include aliphatic diisocyanate compounds such as butane diisocyanate, 1,5-pentamethylene diisocyanate (PDI), 1,6-hexamethylene diisocyanate (HDI), 2,2,4-trimethylhexamethylene diisocyanate (TMDI), and 2,4,4-trimethylhexamethylene diisocyanate (TMDI); alicyclic diisocyanate compounds such as norbornane diisocyanate, isophorone diisocyanate (IPDI), hydrogenated xylylene diisocyanate, and hydrogenated diphenylmethane diisocyanate; aromatic diisocyanate compounds such as tolylene diisocyanate, xylylene diisocyanate, tetramethyl xylylene diisocyanate, diphenylmethane diisocyanate, 1,5-naphthalene diisocyanate, 4,4′-diisocyanato-3,3′-dimethylbiphenyl, and o-tolidine diisocyanate; and isocyanurate-modified products, biuret-modified products, and allophanate-modified products thereof. Any combination of the above may be used.

The diisocyanate (a2) is preferably, for example, hexamethylene diisocyanate (HDI), 1,6-hexamethylene diisocyanate (HDI), isophorone diisocyanate (IPDI), 2,2,4-trimethylhexamethylene diisocyanate (TMDI), or hydrogenated diphenylmethane diisocyanate. Any combination of the above may be used. The diisocyanate (a2) is more preferably isophorone diisocyanate (IPDI). A content of a skeleton of the diisocyanate (a2) in the urethane resin (A) may be 10 mass % or more, 20 mass % or more, or 30 mass % or more. The content may be 90 mass % or less, 80 mass % or less, or 70 mass % or less. A content of the diisocyanate (a2) may be 10 parts by mass or more, 20 parts by mass or more, or 30 parts by mass or more, with respect to 100 parts by mass of the total mass of the raw materials for synthesizing the urethane resin (A). The content may be 90 parts by mass or less, 80 parts by mass or less, or 70 parts by mass or less. In the present specification, the “skeleton of the diisocyanate (a2)” is a structure of the diisocyanate (a2) after two isocyanate groups are removed.

Compound (a3) Having Hydroxyl Group and (Meth)Acryloyl Group The compound (a3) having a hydroxyl group and a (meth)acryloyl group is not particularly limited as long as the urethane resin (A) of the present embodiment can be formed, and may be appropriately selected depending on the intended purpose. Examples of the compound (a3) include hydroxyethyl (meth)acrylate (HEA/HEMA), hydroxypropyl (meth)acrylate (HPA/HPMA), 4-hydroxybutylene (meth)acrylate (4-HBA), trimethylolpropane (meth)acrylate, trimethylolpropane di(meth)acrylate, pentaerythritol (meth)acrylate, pentaerythritol di(meth)acrylate, pentaerythritol tri(meth)acrylate, dipentaerythritol (meth)acrylate, dipentaerythritol di(meth)acrylate, dipentaerythritol tri(meth)acrylate, dipentaerythritol tetra(meth)acrylate, dipentaerythritol penta(meth)acrylate, ditrimethylolpropane (meth)acrylate, ditrimethylolpropane di(meth)acrylate, and ditrimethylolpropane tri(meth)acrylate. In addition, (poly)oxyalkylene-modified products obtained by introducing a (poly)oxyalkylene chain such as a (poly)oxyethylene chain, a (poly)oxypropylene chain, or a (poly)oxytetramethylene chain into the molecular structures of the above-described various compounds having a hydroxyl group and a (meth)acryloyl group, lactone-modified products obtained by introducing a (poly)lactone structure into the molecular structures of the above-described various compounds having a hydroxyl group and a (meth)acryloyl group, and the like can also be used.

The compound (a3) having a hydroxyl group and a (meth)acryloyl group is preferably hydroxyethyl (meth)acrylate (HEA/HEMA), hydroxypropyl (meth)acrylate (HPA/HPMA), 4-hydroxybutylene (meth)acrylate (4-HBA), or lactone-modified hydroxyethyl (meth)acrylate (lactone-modified HEA/HEMA). The lactone-modified hydroxyethyl (meth)acrylate is a lactone-modified product obtained by introducing a (poly)lactone structure into the molecular structure of hydroxyethyl (meth)acrylate.

The compounds (a3) having a hydroxyl group and a (meth)acryloyl group described above can be used alone, or two or more thereof can be used in combination.

A content of a skeleton of the compound (a3) having a hydroxyl group and a (meth)acryloyl group in the urethane resin (A) may be 10 mass % or more, may be 20 mass % or more, or may be 30 mass % or more. The content may be 90 mass % or less, 80 mass % or less, or 70 mass % or less. A content of the compound (a3) having a hydroxyl group and a (meth)acryloyl group may be 10 parts by mass or more, 20 parts by mass or more, or 30 parts by mass or more, with respect to 100 parts by mass of the total mass of the raw materials for synthesizing the urethane resin (A). The content may be 90 parts by mass or less, 80 parts by mass or less, or 70 parts by mass or less. In the present specification, the “skeleton of the compound (a3) having a hydroxyl group and a (meth)acryloyl group” is a structure of the compound (a3) having a hydroxyl group and a (meth)acryloyloxy group.

The urethane resin (A) is preferably a resin represented by the following Formula (1).

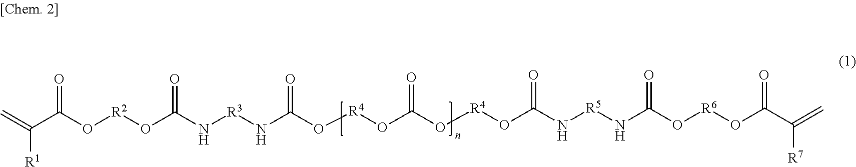

In Formula (1),
R¹ and R⁷ each independently represent a hydrogen atom or a methyl group, and R² and R⁶ are the skeleton of the compound (a3) having a hydroxyl group and a (meth)acryloyl group, and are preferably divalent substituents derived from HEA or HEMA, HPA or HPMA, or 4-HBA lactone-modified HEA/HEMA. The skeleton of the compound (a3) having a hydroxyl group and a (meth)acryloyl group is a divalent group obtained by removing a hydroxyl group and a (meth)acryloyloxy group from the compound (a3).
R³ and R⁵ are the skeleton of the diisocyanate (a2), and are preferably divalent substituents derived from PDI, HDI, IPDI, or TMDI. The skeleton of the diisocyanate (a2) is a divalent group obtained by removing two diisocyanate groups from the diisocyanate (a2).

R⁴ is the skeleton of the polycarbonate diol (a1) represented by Formula (2). It has the same meaning as R₄ of the polycarbonate diol (a1) represented by Formula (2).
R₄ includes at least one substituent which is a branched or linear aliphatic alkylene group. R₄ is an aliphatic, alicyclic, or aliphatic/alicyclic alkylene group. The number of carbon atoms of the at least one branched or linear aliphatic alkylene group in the R⁴ is from 2 to 12, preferably from 4 to 10. The number of carbon atoms is more preferably from 4 to 9.
n is an integer of from 2 to 100.
R₄ may be one type or two or more types, and at least one thereof is —CH₂CH₂CH(CH₃)CH₂CH₂—, —(CH₂)₆—, or —(CH₂)₄—, preferably a combination of —CH₂CH₂CH(CH₃)CH₂CH₂— and —(CH₂)₆—.

The urethane resin (A) is preferably a resin represented by Formula (1), and the substituents in Formula (1) are preferably as follows.
R¹ and R⁷ each independently represent a hydrogen atom or a methyl group,
R² and R⁶ each independently represent —C₂H₄—, —C₃H₆—, —C₄H₈—, or —C₂H₄₀ (COC₅H₁₀)ₛ— (s=from 1 to 4),
R³ and R⁵ each independently represent —C₅H₁₀—, —C₆H₁₂—, —C₁₀H₁₈—, or —C₉H₁₈—, and
R⁴ may be one type or two or more types, and at least one substituent is more preferably a branched or linear aliphatic structure having from 2 to 12 carbon atoms, more preferably a branched or linear aliphatic structure having from 3 to 10 carbon atoms, and still more preferably a branched or linear aliphatic structure having from 4 to 9 carbon atoms. R⁴ may be one type or two or more types, and is more preferably a branched or linear aliphatic structure having from 2 to 12 carbon atoms, more preferably a branched or linear aliphatic structure having from 3 to 10 carbon atoms, and still more preferably a branched or linear aliphatic structure having from 4 to 9 carbon atoms.
R⁴ may be one type or two or more types, and at least one substituent represents an aliphatic structure having from 2 to 12 carbon atoms, a skeleton of isosorbide, a skeleton of cyclohexanedimethanol, a skeleton of 3-methylpentanediol (3MPD), or a skeleton of 2-methyloctanediol (MOD). R₄ may be one type or two or more types, and represents an aliphatic structure having from 2 to 12 carbon atoms, a skeleton of isosorbide, a skeleton of cyclohexanedimethanol, a skeleton of 3-methylpentanediol (3MPD), or a skeleton of 2-methyloctanediol (MOD). Examples of the linear aliphatic structure having from 2 to 12 carbon atoms include —(CH₂)ₛ— (s=from 2 to 12). Examples of the linear aliphatic structure having from 3 to 10 carbon atoms include —(CH₂)ₛ— (s=from 3 to 10). Examples of the branched aliphatic structure having from 2 to 12 carbon atoms include —(CH₂)ₛ—CH(CH₃)—(CH₂)ₜ— (s and t may be 0, and s+t=from 0 to 10), and —(CH₂)ₛ—CH(C₂H₄)—(CH₂)ₜ— (s and t may be 0, and s+t=from 0 to 9). Examples of the branched aliphatic structure having from 3 to 10 carbon atoms include —(CH₂)ₛ—CH(CH₃)—(CH₂)ₜ— (s and t may be 0, and s+t=from 1 to 8), and —(CH₂)ₛ—CH(C₂H₄)—(CH₂)ₜ— (s and t may be 0, and s+t=from 1 to 7).
R₄ preferably represents one or two or more divalent groups selected from the group consisting of —(CH₂)ₛ— (s=from 2 to 12) and —(CH₂)ₛ—CH(CH₃)—(CH₂)ₜ— (s and t may be 0, and s+t=from 0 to 10).

### Structure of Urethane Resin (A)

The urethane resin (A) is obtained by using the polycarbonate diol (a1), the diisocyanate (a2), and the compound (a3) having a hydroxyl group and a (meth)acryloyl group as reaction raw materials. A molar ratio [(a1-1)/(a2-1)/(a3-1)] among a structure (a1-1) derived from the polycarbonate diol (a1) constituting the urethane resin (A), a structure (a2-1) derived from the diisocyanate (a2) constituting the urethane resin (A), and a structure (a3-1) derived from the compound (a3) having a hydroxyl group and a (meth)acryloyl group constituting the urethane resin (A) may be from 5 to 90/from 5 to 90/from 5 to 90, from 10 to 80/from 10 to 80/from 10 to 80, or from 15 to 70/from 15 to 70/from 15 to 70.

### Method for Producing Urethane Resin (A)

A method for producing the urethane resin (A) is not particularly limited, and the urethane resin (A) may be produced by any method. For example, the urethane resin (A) may be produced by a method in which all reaction raw materials containing the polycarbonate diol (a1), the diisocyanate (a2), and the compound (a3) having a hydroxyl group and a (meth)acryloyl group are reacted at once, or may be produced by a method in which the reaction raw materials are sequentially reacted. For example, after reaction raw materials containing the polycarbonate diol (a1) and the diisocyanate (a2) are reacted, the resulting reaction product may be reacted with the compound (a3) having a hydroxyl group and a (meth)acryloyl group. Alternatively, reaction raw materials containing the compound (a3) having a (meth)acryloyl group and the diisocyanate (a2) may be reacted, and then the resulting reaction product may be reacted with the polycarbonate diol (a1). Because a curable resin composition capable of forming an optical three-dimensional shaped object having both sufficient toughness and heat resistance can be obtained, an equivalence ratio [(OH-1+OH-2)/NCO] of a total of a first hydroxyl group (OH-1) of the polycarbonate diol (a1) and a second hydroxyl group (OH-2) of the compound (a3) having a hydroxyl group and a (meth)acryloyl group to the isocyanate groups (NCO) of the diisocyanate (a2) is preferably in a range of from 0.95/1.00 to 1.05/1.00, and more preferably 1/1. An equivalence ratio [OH-1/OH-2] of the first hydroxyl group (OH-1) of the polycarbonate diol (a1) to the second hydroxyl group (OH-2) of the compound (a3) having a hydroxyl group and a (meth)acryloyl group is preferably in a range of from 1.8/1.00 to 2.2/1.00, and more preferably 2/1.

In the production of the urethane resin (A), for example, dibutyltin laurate, dibutyltin acetate, or the like can be used as a catalyst, and the urethane resin (A) can be produced under conditions of a urethanization reaction that is usually performed. If necessary, a solvent such as ethyl acetate, butyl acetate, methyl isobutyl ketone, toluene, or xylene, or a radical polymerizable monomer containing no site reactive with isocyanate and containing no hydroxyl group or amino group may be used as a solvent.

### Characteristics of Urethane Resin (A)

A content of the (meth)acryloyl groups in the urethane resin (A) used in the present embodiment is preferably 0.3 mmol/g or more and 2.0 mmol/g or less, more preferably 0.5 mmol/g or more and 1.7 mmol/g or less, and still more preferably 0.5 mmol/g or more and 1.7 mmol/g or less.

By incorporating the urethane resin (A) having a specific content of (meth)acryloyl groups into the curable resin composition, the curable resin composition can form an optical three-dimensional shaped object having both sufficient toughness and heat resistance, as shown in the following Examples. The content of the (meth)acryloyl groups in the urethane resin (A) can be determined by, for example, a method of assigning each peak of a measurement sample and an internal standard using a ¹H NMR analyzer and determining the content from an integral ratio, or a method of creating a calibration curve from a ratio of a peak derived from an acryloyl group and a specific peak of a standard substance using an IR analyzer and quantifying the content. In the present application, the content of the (meth)acryloyl groups in the urethane resin (A) was calculated based on the content (theoretical value) of the (meth)acryloyl groups in the raw materials.

The number average molecular weight (Mn) of the urethane resin (A) used in the present embodiment is 2000 or more, preferably 2500 or more, and more preferably 3000 or more. The number average molecular weight (Mn) of the urethane resin (A) may be 30000 or less, or may be 1500 or less. By setting the number average molecular weight (Mn) of the urethane resin (A) used in the curable resin composition for stereolithography of the present embodiment within the above range, the curable resin composition can form an optical three-dimensional shaped object having both sufficient toughness and heat resistance as shown in the following Examples.

A number average molecular weight (Mn) of the (meth)acryloyl groups in the urethane resin (A) is obtained by, for example, a measurement method described in Examples.

### Compound (B)

The α,β-unsaturated carbonyl compound (B) (sometimes simply referred to as “compound (B)”) has a glass transition temperature (hereinafter abbreviated as “Tg”) of 50° C. or higher, preferably 60° C. or higher, and more preferably 70° C. or higher, when formed into a polymer. The glass transition temperature may be 250° C. or lower.

In the present specification, the “glass transition temperature (Tg)” of a monomer “when formed into a polymer” is the glass transition temperature (Tg) of a polymer (homopolymer) of the monomer.

The α,β-unsaturated carbonyl compound (B) may contain no (meth)acryloyl group. Specific examples of the compound (B) containing no (meth)acryloyl group include methyl 2-(allyloxymethyl)acrylate (methyl 2-allyloxymethylacrylate).

The α,β-unsaturated carbonyl compound (B) is preferably a compound having one (meth)acryloyl group.

The compound (B) may also include a nitrogen-containing (meth)acrylic compound.

Examples of the compound (B) include (meth)acrylic compounds such as (meth)acrylate compounds and (meth)acrylamides.

Examples of the compound (B) include monofunctional (meth)acrylate compounds such as isobornyl acrylate (Tg: 94° C.), isobornyl methacrylate (Tg: 180° C.), dicyclopentenyl acrylate (Tg: 120° C.), dicyclopentanyl acrylate (Tg: 120° C.), dicyclopentanyl methacrylate (Tg: 175° C.), acryloylmorpholine (Tg: 145° C.), phenyl methacrylate (Tg: 110° C.), dicyclopentenyl acrylate (Tg: 120° C.), adamantyl methacrylate (Tg: 250° C.), and (2-oxo-1,3-dioxolan-4-yl)methyl methacrylate (Tg: 212° C.).

The compounds (B) can be used alone, or two or more thereof can be used in combination.

Among these, (meth)acrylic compounds having a cyclic structure such as a condensed polycyclic structure or a heterocyclic structure are preferable, and isobornyl acrylate (Tg: 94° C.), isobornyl methacrylate (Tg: 180° C.), dicyclopentenyl acrylate (Tg: 120° C.), dicyclopentanyl acrylate (Tg: 120° C.), and dicyclopentanyl methacrylate (Tg: 175° C.) are more preferable.

When two or more of the compounds (B) are used in combination, the Tg of a copolymer of two or more α,β-unsaturated carbonyl compounds is preferably 60° C. or higher.

The α,β-unsaturated carbonyl compound (B) may also include a nitrogen-containing (meth)acrylic compound, but is more preferably a (meth)acrylamide represented by the following Formula (3) from the viewpoint of adhesiveness of the cured product to a shaping stage.

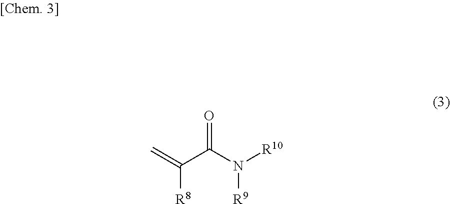

In Formula (3), R^{a} represents a hydrogen atom or a methyl group. R⁹ and R¹⁰ are each independently a monovalent hydrocarbon group with from 1 to 40 carbon atoms which may have a cyclic structure, a group in which some of the carbon atoms of the hydrocarbon group are substituted with oxygen atoms or nitrogen atoms, or a hydrogen atom, R⁹ and R¹⁰ may be bonded to each other to form a ring, and the monovalent hydrocarbon group with from 1 to 40 carbon atoms represented by each of R⁹ and R¹⁰ may or may not contain an unsaturated double bond.

Examples of the compound (B) represented by Formula (3) include acryloylmorpholine, isopropylacrylamide, dimethylacrylamide, hydroxyethylacrylamide, and diethylacrylamide, and among these, a (meth)acrylamide compound having a cyclic structure such as a condensed polycyclic structure or a heterocyclic structure is preferable, and acryloylmorpholine (Tg: 145° C.) is particularly preferable.

### Compound (C)

The curable resin composition for stereolithography of the present embodiment preferably further contains a compound (C) having two or more (meth)acryloyl groups (sometimes simply referred to as “compound (C)”).

The compound (C) having two or more (meth)acryloyl groups has a glass transition temperature (Tg) of 60° C. or higher when formed into a polymer. The glass transition temperature (Tg) of the polymer of the compound (C) is preferably 70° C. or higher, and more preferably 75° C. or higher. The glass transition temperature may be 250° C. or lower.

Examples of the compound (C) having two or more (meth)acryloyl groups include dipropylene glycol diacrylate (Tg: 102° C.), tricyclodecanedimethanol diacrylate (Tg: 110° C.), hydroxypivalic acid neopentyl glycol diacrylate (Tg: 111° C.), isosorbide diacrylate (Tg: 175° C.), and bisphenol A diglycidyl diacrylate (Tg: 79° C.). These compounds (C) can be used alone, or two or more thereof can be used in combination.

Among the compounds (C), a compound in which the Tg of the polymer of the bifunctional (meth)acrylic compound is 40° C. or higher is preferable because a curable resin composition capable of forming a cured product having a low viscosity and excellent mechanical properties is obtained. Among these, dipropylene glycol diacrylate (Tg: 102° C.), tricyclodecanedimethanol diacrylate (Tg: 110° C.), and hydroxypivalic acid neopentyl glycol diacrylate (Tg: 111° C.) are more preferable.

In the case where two or more of the compounds (C) are used in combination, the Tg of a copolymer of two or more bifunctional (meth)acrylic compounds is preferably 60° C. or higher.

The α,β-unsaturated carbonyl compound (B) and the compound (C) having two or more (meth)acryloyl groups can be used in combination. In this case, the Tg of a copolymer of the (meth)acrylic compound used in combination is preferably 60° C. or higher.

### Additional (Meth)acrylic Compound (D)

As long as the effects of the present invention are not inhibited, the curable resin composition for stereolithography of the present embodiment may further contain, as necessary, an additional (meth)acrylic compound (D) such as a trifunctional or higher functional (meth)acrylic compound (sometimes simply referred to as “compound (D)”) in combination with the α,β-unsaturated carbonyl compound (B) and the compound (C) having two or more (meth)acryloyl groups. In this case, the Tg of a copolymer of the additional (meth)acrylic compound (D) used in combination is preferably 40° C. or higher.

Examples of the trifunctional or higher functional (meth)acrylic compound include trifunctional (meth)acrylates such as EO-modified glycerol acrylate, PO-modified glycerol triacrylate, pentaerythritol triacrylate, EO-modified phosphoric acid triacrylate, trimethylolpropane triacrylate, caprolactone-modified trimethylolpropane triacrylate, HPA-modified trimethylolpropane triacrylate, (EO)-or (PO)-modified trimethylolpropane triacrylate, alkyl-modified dipentaerythritol triacrylate, and tris(acryloxyethyl) isocyanurate;
tetrafunctional (meth)acrylates such as ditrimethylolpropane tetraacrylate, pentaerythritol ethoxytetraacrylate, and pentaerythritol tetraacrylate;
pentafunctional (meth)acrylates such as dipentaerythritol hydroxypentaacrylate and alkyl-modified dipentaerythritol pentaacrylate; and
hexafunctional (meth)acrylates such as dipentaerythritol hexaacrylate.

These trifunctional or higher functional (meth)acrylic compounds (more specifically, (meth)acrylates) can be used alone, or two or more thereof can be used in combination.

### Photopolymerization Initiator

The curable resin composition for stereolithography of the present embodiment further contains a photopolymerization initiator. Examples of the photopolymerization initiator include 1-hydroxycyclohexyl phenyl ketone, 2-hydroxy-2-methyl-1-phenylpropane-1-one, 1-[4-(2-hydroxyethoxy)phenyl]-2-hydroxy-2-methyl-1-propane-1-one, thioxanthone and thioxanthone derivatives, 2,2′-dimethoxy-1,2-diphenylethane-1-one, diphenyl (2,4,6-trimethoxybenzoyl) phosphineoxide, 2,4,6-trimethylbenzoyldiphenyl phosphineoxide, bis(2,4,6-trimethylbenzoyl)phenyl phosphineoxide, 2-methyl-1-(4-methylthiophenyl)-2-morpholinopropane-1-one, 2-benzyl-2-dimethylamino-1-(4-morpholinophenyl)-1-butanone, ethyl phenyl(2,4,6-trimethylbenzoyl)phosphinate, and polymeric TPO-L.

Examples of additional commercially available products of the photopolymerization initiator include “Omnirad-1173”, “Omnirad-184”, “Omnirad-127”, “Omnirad-2959”, “Omnirad-369”, “Omnirad-379”, “Omnirad-907”, “Omnirad-4265”, “Omnirad-1000”, “Omnirad-651”, “Omnirad-TPO”, “Omnirad-819”, “Omnirad-2022”, “Omnirad-2100”, “Omnirad-2959”, “Omnirad-754”, “Omnirad-784”, “Omnirad-500”, “Omnirad-81”, “Omnirad-TPO-L”, and “Omnipol TP” (available from IGM), “Kayacure-DETX”, “Kayacure-MBP”, “Kayacure-DMBI”, “Kayacure-EPA”, and “Kayacure-OA” (available from Nippon Kayaku Co., Ltd.), “Vicure-10” and “Vicure-55” (available from Stauffer Chemical Company), “Trigonal P1” (available from Akzo Co., Ltd.), “Sandoray 1000” (available from Sandoz Co., Ltd.), “Deap” (available from Upjohn Company), “Quantacure-PDO”, “Quantacure-ITX”, and “Quantacure-EPD” (available from Ward Blenkinsop & Co., Ltd.), and “Runtecure-1104” (available from Runtec Chemical Co., Ltd.).

An amount of the photopolymerization initiator to be added is preferably in a range of from 1 to 20 mass % in the curable resin composition for stereolithography.

### Additional Additive

The curable resin composition for stereolithography of the present embodiment can also contain various additives such as a photosensitizer, an ultraviolet absorber, an antioxidant, a polymerization inhibitor, a silicon-based additive, a fluorine-based additive, a silane coupling agent, a phosphate ester compound, organic beads, inorganic fine particles, an organic filler, an inorganic filler, a rheology control agent, a defoaming agent, and a colorant, as necessary.

The curable resin composition for stereolithography of the present embodiment can further contain a photosensitizer as necessary to improve the curability.

Examples of the photosensitizer include amine compounds such as aliphatic amine and aromatic amine, urea compounds such as o-tolylthiourea, condensed polycyclic compounds such as anthraquinone derivatives, and sulfur compounds such as sodium diethyldithiophosphate and s-benzylisothiuronium p-toluenesulfonate.

Examples of the ultraviolet absorber include triazine derivatives such as 2-[4-{(2-hydroxy-3-dodecyloxypropyl)oxy}-2-hydroxyphenyl]-4,6-bis(2,4-dimethylphenyl)-1,3,5-triazine and 2-[4-{(2-hydroxy-3-tridecyloxypropyl)oxy}-2-hydroxyphenyl]-4,6-bis(2,4-dimethylphenyl)-1,3,5 triazine, 2-(2′-xanthenecarboxy-5′-methylphenyl)benzotriazole, 2-(2′-o-nitrobenzyloxy-5′-methylphenyl)benzotriazole, 2-xanthenecarboxy-4-dodecyloxybenzophenone, and 2-o-nitrobenzyloxy-4-dodecyloxybenzophenone. These ultraviolet absorbers can be used alone, or two or more thereof can be used in combination.

Examples of the antioxidant include hindered phenol-based antioxidants, hindered amine-based antioxidants, organic sulfur-based antioxidants, and phosphate ester-based antioxidants. These antioxidants can be used alone, or two or more thereof can be used in combination.

Examples of the polymerization inhibitor include hydroquinone, methoquinone, di-t-butylhydroquinone, p-methoxyphenol, butylhydroxytoluene, and nitrosamine salts.

Examples of the silicon-based additive include polyorganosiloxanes having an alkyl group or a phenyl group such as dimethylpolysiloxane, methylphenylpolysiloxane, cyclic dimethylpolysiloxane, methylhydrogenpolysiloxane, a polyether-modified dimethylpolysiloxane copolymer, a polyester-modified dimethylpolysiloxane copolymer, a fluorine-modified dimethylpolysiloxane copolymer, and an amino-modified dimethylpolysiloxane copolymer, polydimethylsiloxane having a polyether-modified acrylic group, and polydimethylsiloxane having a polyester-modified acrylic group. These silicon-based additives can be used alone, or two or more thereof can be used in combination.

Examples of the fluorine-based additive include “Megaface” series available from DIC Corporation. These fluorine-based additives can be used alone, or two or more thereof can be used in combination.

Examples of the silane coupling agent include vinyl-based silane coupling agents such as vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, special aminosilane, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatepropyltriethoxysilane, allyltrichlorosilane, allyltriethoxysilane, allyltrimethoxysilane, diethoxymethylvinylsilane, vinyltrimethoxysilane, vinyltriethoxysilane, and vinyltris(2-methoxyethoxy)silane;
epoxy-based silane coupling agents such as diethoxy(glycidyloxypropyl)methylsilane, 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane;
styrene-based silane coupling agents such as p-styryltrimethoxysilane;
(meth)acryloxy-based silane coupling agents such as 3-methacryloxypropylmethyldimethoxysilane, 3-acryloxypropyltrimethoxysilane, 3-methacryloxypropyltrimethoxysilane, 3-methacryloxypropylmethyldiethoxysilane, and 3-methacryloxypropyltriethoxysilane;
amino-based silane coupling agents such as N-2(aminoethyl)-3-aminopropylmethyldimethoxysilane, N-2(aminoethyl)-3-aminopropyltrimethoxysilane, N-2(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane;
ureido-based silane coupling agents such as 3-ureidopropyltriethoxysilane;
chloropropyl-based silane coupling agents such as 3-chloropropyltrimethoxysilane;
mercapto-based silane coupling agents such as 3-mercaptopropylmethyldimethoxysilane and 3-mercaptopropyltrimethoxysilane;
sulfide-based silane coupling agents such as bis(triethoxysilylpropyl)tetrasulfide; and
isocyanate-based silane coupling agents such as 3-isocyanatepropyltriethoxysilane. These silane coupling agents can be used alone, or two or more thereof can be used in combination.

Examples of the phosphate ester compound include those having a (meth)acryloyl group in the molecular structure, and examples of commercially available products include “Kayamer PM-2” and “Kayamer PM-21” available from Nippon Kayaku Co., Ltd., “Light Ester P-1M”, “Light Ester P-2M”, and “Light Acrylate P-1A (N)” available from Kyoeisha Chemical Co., Ltd., “SIPOMER PAM 100”, “SIPOMER PAM 200”, “SIPOMER PAM 300”, and “SIPOMER PAM 4000” available from SOLVAY, “Viscoat #3PA” and “Viscoat #3PMA” available from Osaka Organic Chemical Industry Ltd., “New Frontier S 23A” available from DKS Co., Ltd., and “SIPOMER PAM 5000” available from SOLVAY, which is a phosphate ester compound having an allyl ether group in the molecular structure.

Examples of the organic beads include polymethyl methacrylate beads, polycarbonate beads, polystyrene beads, polyacrylic styrene beads, silicone beads, glass beads, acrylic beads, benzoguanamine-based resin beads, melamine-based resin beads, polyolefin-based resin beads, polyester-based resin beads, polyamide resin beads, polyimide-based resin beads, polyethylene fluoride resin beads, and polyethylene resin beads. These organic beads can be used alone, or two or more thereof can be used in combination. An average particle diameter of these organic beads is preferably in a range of from 1 to 10 μm.

Examples of the inorganic fine particles include fine particles of silica, alumina, zirconia, titania, barium titanate, antimony trioxide, and the like. These inorganic fine particles can be used alone, or two or more thereof can be used in combination. An average particle diameter of these inorganic fine particles is preferably in a range of from 95 to 250 nm, and particularly preferably in a range of from 100 to 180 nm.

In the case of containing inorganic fine particles, a dispersion aid can be used.

Examples of the dispersion aid include phosphate ester compounds such as isopropyl acid phosphate, triisodecyl phosphite, and ethylene oxide-modified phosphoric acid dimethacrylate. These dispersion aids can be used alone, or two or more thereof can be used in combination.

Examples of commercially available products of the dispersion aid include “Kayamer PM-21” and “Kayamer PM-2” available from Nippon Kayaku Co., Ltd., and “Light Ester P-2M” available from Kyoeisha Chemical Co., Ltd.

Examples of the organic filler include plant-derived solvent-insoluble substances such as cellulose, lignin, and cellulose nanofibers.

Examples of the inorganic filler include glass (particles), silica (particles), alumina silicate, talc, mica, aluminum hydroxide, alumina, calcium carbonate, and carbon nanotubes.

Examples of the rheology control agent include amide waxes such as “DISPARLON 6900” available from Kusumoto Chemicals, Ltd., urea-based rheology control agents such as “BYK410” available from BYK, polyethylene waxes such as “DISPARLON 4200” available from Kusumoto Chemicals, Ltd., and cellulose-acetate-butyrates such as “CAB-381-2” and “CAB 32101” available from Eastman Chemical Company.

Examples of the defoaming agent include oligomers containing fluorine or silicon atoms, higher fatty acids, and oligomers such as acrylic polymers.

Examples of the colorant include pigments and dyes.

As the pigment, for example, a known inorganic pigment or organic pigment can be used.

Examples of the inorganic pigment include titanium oxide, antimony red, red iron oxide, cadmium red, cadmium yellow, cobalt blue, Prussian blue, ultramarine, carbon black, and graphite.

Examples of the organic pigment include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, and azo pigments. These pigments can be used alone, or two or more thereof can be used in combination.

Examples of the dyes include azo dyes, such as monoazo and disazo, metal complex salt dyes, naphthol dyes, anthraquinone dyes, indigo dyes, carbonium dyes, quinoneimine dyes, cyanine dyes, quinoline dyes, nitro dyes, nitroso dyes, benzoquinone dyes, naphthoquinone dyes, naphthalimide dyes, perinone dyes, phthalocyanine dyes, and triarylmethane-based dyes. These dyes can be used alone, or two or more thereof can be used in combination.

Characteristics of Curable Resin Composition for Stereolithography A content of the urethane resin (A) in the curable resin composition for stereolithography of the present embodiment is preferably 1 mass % or more and 60 mass % or less, more preferably 5 mass % or more and 55 mass % or less, and still more preferably 10 mass % or more and 50 mass % or less. By setting the content of the urethane resin (A) in the curable resin composition for stereolithography of the present embodiment within the above range, the curable resin composition can form an optical three-dimensional shaped object having both sufficient toughness and heat resistance as shown in the following Examples.

A content of the α,β-unsaturated carbonyl compound (B) in the curable resin composition for stereolithography of the present embodiment is preferably 20 mass % or more and 90 mass % or less, more preferably 25 mass % or more and 80 mass % or less, and still more preferably 30 mass % or more and 75 mass % or less. By setting the content of the compound (B) in the curable resin composition for stereolithography of the present embodiment within the above range, the curable resin composition can form an optical three-dimensional shaped object having both sufficient toughness and heat resistance as shown in the following Examples.

When the compound (C) having two or more (meth)acryloyl groups is contained in the curable resin composition for stereolithography of the present embodiment, a content thereof is preferably 1 mass % or more and 50 mass % or less, more preferably 3 mass % or more and 40 mass % or less, and still more preferably 5 mass % or more and 30 mass % or less. By setting the content of the compound (C) in the curable resin composition for stereolithography of the present embodiment within the above range, the curable resin composition can form an optical three-dimensional shaped object having both sufficient toughness and heat resistance as shown in the following Examples.

### Cured Product

A cured product according to an embodiment of the present invention is a cured reaction product of the above-described curable resin composition for stereolithography. The cured product of the present embodiment can be obtained by irradiating the curable resin composition for stereolithography with an active energy ray.

Examples of the active energy ray include ultraviolet rays, electron beams, α-rays, β-rays, γ-rays and other ionizing radiations. In addition, in a case where ultraviolet rays are used as the active energy rays, irradiation may be performed in an inert gas atmosphere such as nitrogen gas or in an air atmosphere in order to efficiently perform a curing reaction by ultraviolet rays.

As an ultraviolet ray generating source, an ultraviolet lamp is generally used from the viewpoint of practicality and economic efficiency. Specific examples of the ultraviolet lamp include a low-pressure mercury lamp, a high-pressure mercury lamp, an ultrahigh-pressure mercury lamp, a xenon lamp, a gallium lamp, a metal halide lamp, sunlight, and an LED.

An integrated light quantity of the active energy ray is not particularly limited, but is preferably from 50 to 5000 mJ/cm², and more preferably from 300 to 1000 mJ/cm². An integrated light quantity falling within the above range is preferable because the generation of an uncured portion can be prevented or suppressed.

### Three-Dimensional Shaped Object

A three-dimensional shaped object according to an embodiment of the present invention is formed of the cured product. The three-dimensional shaped object of the present embodiment can be fabricated by the above-described known optical three-dimensional shaping method.

Examples of the optical three-dimensional shaping method include a stereolithography (SLA) method, a digital light processing (DLP) method, and an inkjet method.

The stereolithography (SLA) method is a method of performing three-dimensional shaping by irradiating a tank of a liquid curable resin composition with an active energy ray such as a laser beam at a point and curing the composition layer by layer while moving a shaping stage.

The digital light processing (DLP) method is a method of performing three-dimensional shaping by irradiating a tank of a liquid curable resin composition with an active energy ray such as an LED in a plane and curing the composition layer by layer while moving a shaping stage.

The inkjet stereolithography is a method in which a cured thin film is formed by discharging fine droplets of a curable resin composition for stereolithography from a nozzle to draw a predetermined shape pattern and then irradiating the droplets with ultraviolet rays.

Among these optical three-dimensional shaping methods, the DLP method is preferable because it enables high-speed shaping in a plane.

The DLP three-dimensional shaping method is not particularly limited as long as it is a method using a DLP stereolithography system. As shaping conditions, a lamination pitch of stereolithography needs to be in a range of from 0.01 to 0.2 mm, an irradiation wavelength needs to be in a range of from 350 to 410 nm, light intensity needs to be in a range of from 0.5 to 50 mW/cm², and the integrated light quantity per layer needs to be in a range of from 1 to 100 mJ/cm², from the viewpoint of improving the shaping accuracy of the three-dimensional shaped object. Among these, the lamination pitch of stereolithography is preferably in a range of from 0.02 to 0.1 mm, the irradiation wavelength is preferably in a range of from 380 to 410 nm, the light intensity is preferably in a range of from 5 to 15 mW/cm², and the integrated light quantity per layer is preferably in a range of from 5 to 15 mJ/cm², from the viewpoint of further improving the shaping accuracy of the three-dimensional shaped object.

The three-dimensional shaped object of the present embodiment is an optical three-dimensional shaped object having both sufficient toughness and heat resistance, and thus can be suitably used in, for example, automobile parts, aerospace parts, electric and electronic parts, home appliances, building materials, and the like.

### EXAMPLES

The present invention will be specifically described with reference to Examples and Comparative Examples below. However, the present invention is not limited to these examples.

Materials used in the following Synthesis Examples, Examples, and the like are as follows.

“Polycarbonate Diol (a1)”
C-2050, polycarbonate diol available from Kuraray Co., Ltd., a copolymer of 3-methylpentanediol (3MPD)/hexanediol (C₆)=50/50 (molar ratio), Mw=2000
C-2090, polycarbonate diol available from Kuraray Co., Ltd., a copolymer of 3-methylpentanediol (3MPD)/hexanediol (C₆)=90/10 (molar ratio), Mw=2000
C-3050, polycarbonate diol available from Kuraray Co., Ltd., a copolymer of 3-methylpentanediol (3MPD)/hexanediol (C₆)=50/50 (molar ratio), Mw=3000
C-3090, polycarbonate diol available from Kuraray Co., Ltd., a copolymer of 3-methylpentanediol (3MPD)/hexanediol (C₆)=90/10 (molar ratio), Mw=3000
C-2015N, polycarbonate diol available from Kuraray Co., Ltd., a copolymer of 2-methyloctanediol (MOD)/nonanediol (C₉)=85/15 (molar ratio), Mw=2000
C-2065N, polycarbonate diol available from Kuraray Co., Ltd., a copolymer of 2-methyloctanediol (MOD)/nonanediol (C₉)=65/35 (molar ratio), Mw=2000
C-1090, polycarbonate diol available from Kuraray Co., Ltd., a copolymer of 3-methylpentanediol (3MPD)/hexanediol (C₆)=90/10 (molar ratio), Mw=1000
Duranol G3450J, polycarbonate diol available from Asahi Kasei Corporation, a copolymer of propanediol (C₃)/butanediol (C₄)=50/50 (molar ratio), Mn=800
Duranol G3452, polycarbonate diol available from Asahi Kasei Corporation, a copolymer of propanediol (C₃)/butanediol (C₄)=50/50 (molar ratio), Mn=2000
Duranol T5651, polycarbonate diol available from Asahi Kasei Corporation, a copolymer of pentanediol/hexanediol (C₆)=50/50 (molar ratio), Mn=1000
   “Diisocyanate (a2)”
Isophorone diisocyanate (IPDI): diisocyanate represented by the following Formula (a2-1)

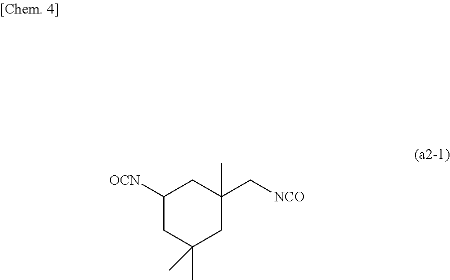

Sumidur N3300: isocyanurate-type hexamethylene diisocyanate (HDI nurate) represented by the following Formula (a2-2)

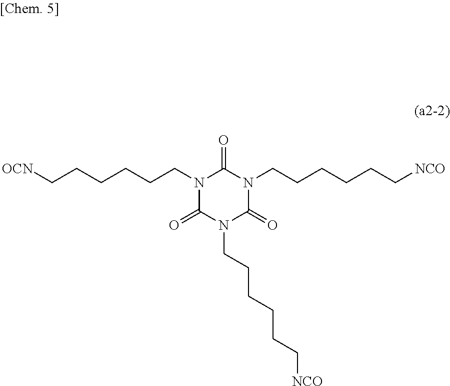

“Compound (a3) having a hydroxyl group and a (meth)acryloyl group”
Placcel FA4DT 4 mol caprolactone addition-type 2-hydroxyethyl acrylate (ε-lactone-modified HEA) represented by the following Formula (a3-1), hydroxyl value: 98.1 KOH mg/g

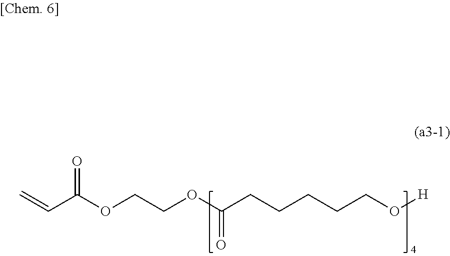

### “Compound (B)”

ACMO: acryloyl morpholine represented by the following Formula (B-1) (available from KJ Chemicals Corporation), Tg: 145° C., number of functional groups: 1

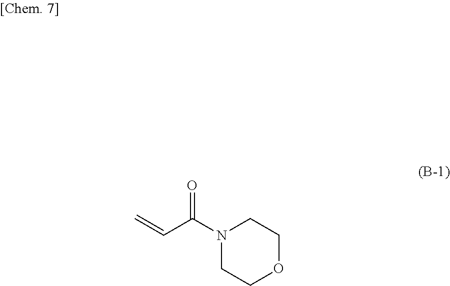

IBXA: isobornyl acrylate represented by the following Formula (B-2) (available from Osaka Organic Chemical Industry Ltd.), Tg: 97° C., number of functional groups: 1

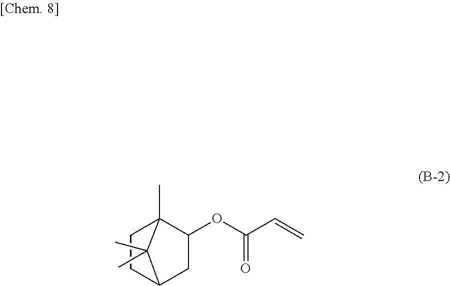

IBXMA: isobornyl methacrylate represented by the following Formula (B-3) (available from Osaka Organic Chemical Industry Ltd.), Tg: 97° C., number of functional groups: 1

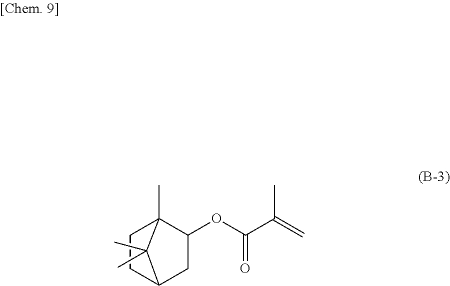 [SMILES: C=C(C)C(=O)OC1CC2CCC1(C)C2(C)C]

AOMA: methyl 2-allyloxymethylacrylate cyclopolymerizable monomer represented by the following Formula (B-4) (Nippon Shokubai Co., Ltd.), Tg: 78° C.

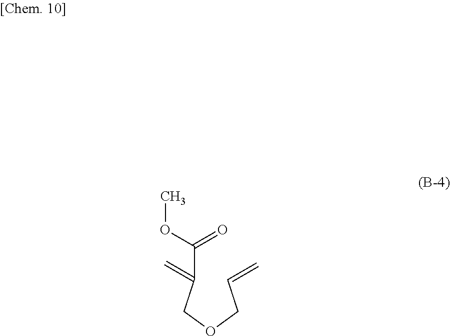

“Monomers Other than the Above”
MIRAMER M1130, trimethylcyclohexyl acrylate represented by the following Formula (B-5) (available from Miwon), Tg: 43° C., number of functional groups 1

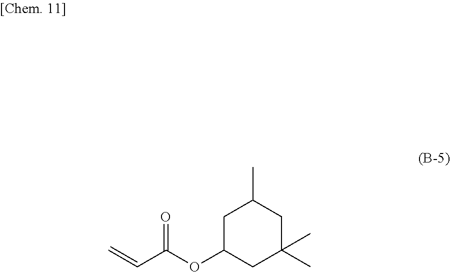

### “Compound (C)”

MIRAMER M262: tricyclodecanedimethanol diacrylate (available from MIWON) represented by the following Formula (C-1), Tg: 110° C., number of functional groups: 2

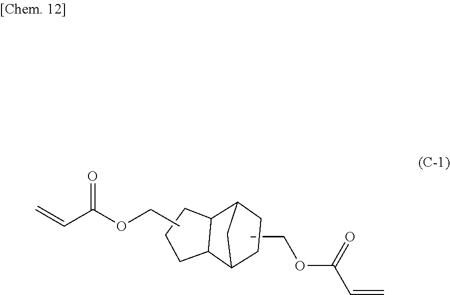

NK Ester DCP: tricyclodecanedimethanol dimethacrylate (available from Shin-Nakamura Chemical Co., Ltd.) represented by the following Formula (C-2), Tg: 112° C., number of functional groups: 2

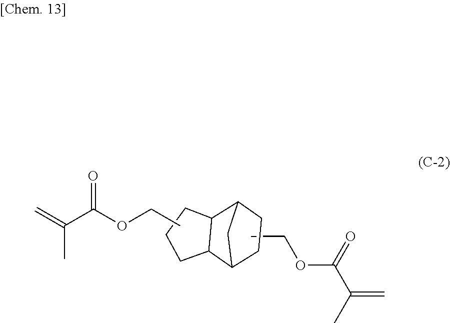

Aronix M-2545: isosorbide diacrylate represented by the following Formula (C-3) (available from Toagosei Co., Ltd.), Tg: 174° C., number of functional groups: 2

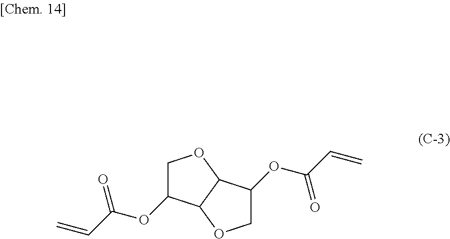 [SMILES: C=CC(=O)OC1COC2C(OC(=O)C=C)COC12]

Epoxy Ester 3000A (available from Kyoeisha Chemical Co., Ltd.), bisphenol A diglycidyl ether diacrylate represented by the following Formula (C-4), Tg: 79° C., number of functional groups: 2

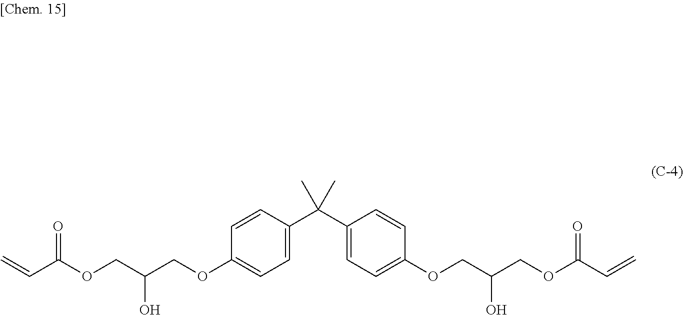 [SMILES: C=CC(=O)OCC(O)COc1ccc(C(C)(C)c2ccc(OCC(O)COC(=O)C=C)cc2)cc1]

MIRAMER PE250: bisphenol A diglycidyl ether dimethacrylate represented by the following Formula (C-5) (available from MIWON), Tg: 122° C., number of functional groups: 2

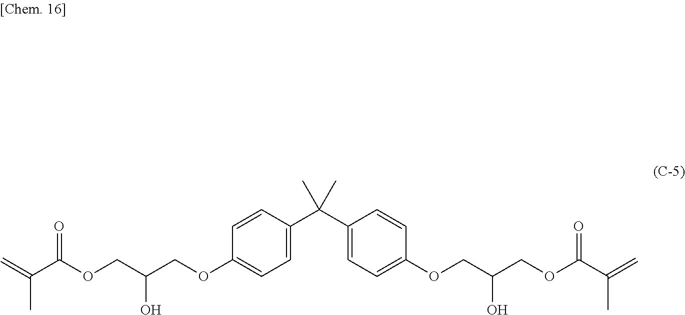 [SMILES: C=C(C)C(=O)OCC(O)COc1ccc(C(C)(C)c2ccc(OCC(O)COC(=O)C(=C)C)cc2)cc1]

### “Initiator”

TPO (1108): Runtecure1108 (available from Runtec Chemical Co., Ltd.)

In the present examples, the number average molecular weight (Mn) is a value measured under the following conditions using gel permeation chromatography (GPC).

Measurement apparatus: HLC-8220 available from Tosoh Corporation Column: Guard column HXL-H available from Tosoh Corporation
+TSKgel G5000HXL available from Tosoh Corporation
+TSKgel G4000HXL available from Tosoh Corporation
+TSKgel G3000HXL available from Tosoh Corporation
+TSKgel G2000HXL available from Tosoh Corporation
Detector: RI (differential refractometer)
Data processing: SC-8010 available from Tosoh Corporation
Measurement conditions: Column temperature: 40° C.
Solvent: tetrahydrofuran
Flow rate: 1.0 ml/min
Standard: polystyrene
Sample: a tetrahydrofuran solution of 0.4 mass % in terms of resin solid content filtered through a microfilter (100 μl)

### Synthesis Example 1: Synthesis of Urethane (Meth)Acrylate (A1)

Isophorone diisocyanate (IPDI) (83 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-2050 (370 parts by mass) available from Kuraray Co., Ltd. was charged in portions over 1 hour. After the charging, the mixture was reacted at 70° C. for 3 hours, and then hydroxyethyl acrylate (HEA) (45 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A1) as the “urethane resin (A) having two (meth)acryloyl groups” according to the present embodiments.

The content of the (meth)acryloyl groups per g of the urethane (meth)acrylate (A1) calculated from the content (theoretical value) of the acryloyl groups in the raw materials was 0.75 mmol (shown in Table 1 below; the content of the (meth)acryloyl groups in each of urethane (meth)acrylates obtained in the following Synthesis Examples is also shown in Table 1). The number average molecular weight (Mn) of the urethane (meth)acrylate (A1) was 2700 (shown in Table 1 below; the number average molecular weight (Mn) of each of urethane (meth)acrylates obtained in the following Synthesis Examples is also shown in Table 1).

### Synthesis Example 2: Synthesis of Urethane (Meth)Acrylate (A2)

Isophorone diisocyanate (IPDI) (83 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-2090 (370 parts by mass) available from Kuraray Co., Ltd. was charged in portions over 1 hour. After the charging, the mixture was reacted at 70° C. for 3 hours, and then hydroxyethyl acrylate (HEA) (45 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A2). The number average molecular weight (Mn) of the urethane resin (A2) was 2700.

### Synthesis Example 3: Synthesis of Urethane (Meth)Acrylate (A3)

Isophorone diisocyanate (IPDI) (58 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-3050 (410 parts by mass) available from Kuraray Co., Ltd. was charged in portions over 1 hour. After the charging, the mixture was reacted at 70° C. for 3 hours, and then hydroxyethyl acrylate (HEA) (31 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A3). The number average molecular weight (Mn) of the urethane resin (A3) was 3900.

### Synthesis Example 4: Synthesis of Urethane (Meth)Acrylate (A4)

Isophorone diisocyanate (IPDI) (61 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-3090 (405 parts by mass) available from Kuraray Co., Ltd. was charged in portions over 1 hour. After the charging, the mixture was reacted at 70° C. for 3 hours, and then hydroxyethyl acrylate (HEA) (33 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A4). The number average molecular weight (Mn) of the urethane resin (A4) was 3700.

### Synthesis Example 5: Synthesis of Urethane (Meth)Acrylate (A5)

Isophorone diisocyanate (IPDI) (82 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-2015N (373 parts by mass) available from Kuraray Co., Ltd. was charged in portions over 1 hour. After the charging, the mixture was reacted at 70° C. for 3 hours, and then hydroxyethyl acrylate (HEA) (44 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A5). The number average molecular weight (Mn) of the urethane resin (A5) was 2700.

### Synthesis Example 6: Synthesis of Urethane (Meth)Acrylate (A6)

Isophorone diisocyanate (IPDI) (83 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-2065N (371 parts by mass) available from Kuraray Co., Ltd. was charged in portions over 1 hour. After the charging, the mixture was reacted at 70° C. for 3 hours, and then hydroxyethyl acrylate (HEA) (45 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A6). The number average molecular weight (Mn) of the urethane resin (A6) was 2700.

### Synthesis Example 7: Synthesis of Urethane (Meth)acrylate (A7)

Isophorone diisocyanate (IPDI) (80 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and G3452 (376 parts by mass) available from Asahi Kasei Corporation was charged in portions over 1 hour. After the charging, the mixture was reacted at 70° C. for 3 hours, and then hydroxyethyl acrylate (HEA) (43 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (A7). The number average molecular weight (Mn) of the urethane resin (A7) was 2800.

### Synthesis Example 8: Synthesis of Urethane (Meth)Acrylate (B1)

Isophorone diisocyanate (IPDI) (131 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and Kuraray Polyol C-1090 (297 parts by mass) available from Kuraray Co., Ltd. was charged in portions over 1 hour.

After the charging, the mixture was reacted at 70° C. for 3 hours, and then hydroxyethyl acrylate (HEA) (71 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (B1). The number average molecular weight (Mn) of the urethane resin (B1) was 1700. Synthesis Example 9: Synthesis of Urethane (Meth)acrylate (B2)

Isophorone diisocyanate (IPDI) (147 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and G3450J (271 parts by mass) available from Asahi Kasei Corporation was charged in portions over 1 hour. After the charging, the mixture was reacted at 70° C. for 3 hours, and then hydroxyethyl acrylate (HEA) (80 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (B2). The number average molecular weight (Mn) of the urethane resin (B2) was 1500.

### Synthesis Example 10: Synthesis of Urethane (Meth)Acrylate (B3)

Isophorone diisocyanate (IPDI) (131 parts by mass), tert-butylhydroxytoluene (1.0 parts by mass), methoxyhydroquinone (0.1 parts by mass), and dibutyltin diacetate (0.1 parts by mass) were added to a 1-liter flask equipped with a stirrer, a gas introduction tube, a condenser, and a thermometer, the temperature was raised to 70° C., and T5651 (297 parts by mass) available from Asahi Kasei Corporation was charged in portions over 1 hour. After the charging, the mixture was reacted at 70° C. for 3 hours, and then hydroxyethyl acrylate (HEA) (71 parts by mass) was added dropwise over 1 hour. After the dropwise addition, the reaction was performed at 70° C. until the infrared absorption spectrum of 2250 cm⁻¹ indicating an isocyanate group disappeared, thereby obtaining urethane (meth)acrylate (B3). The number average molecular weight (Mn) of the urethane resin (B3) was 1700.

### Synthesis Example 11: Synthesis of Urethane (Meth)Acrylate (B4)

Placcel FA4DT (s-lactone-modified HEA represented by Formula (a3-1)) (224 parts by mass) available from Daicel Corporation, tert-butylhydroxytoluene (0.6 parts by mass), methoxyhydroquinone (0.06 parts by mass), and dibutyltin diacetate (0.06 parts by mass) were added to a 1-liter flask equipped with a stirrer, a gas introduction tube, a condenser, and a thermometer, the temperature was raised to 70° C., and Sumidur N3300 (HDI nurate represented by Formula (a2-2)) (75 parts by mass) available from Sumika Bayer Urethane Co., Ltd. was charged in portions over 1 hour. After the charging, the reaction was performed at 70° C. until the infrared absorption spectrum of 2250 cm-1 indicating an isocyanate group disappeared, thereby obtaining urethane (meth)acrylate (B4). The number average molecular weight (Mn) of the urethane resin (B4) was 2300.

The compositions and evaluation results of the urethane resins obtained in Synthesis Examples 1 to 11 are shown in Table 1 below.

TABLE 1

| | | | | | | | Raw material | | | |
|---|---|---|---|---|---|---|---|---|---|---|
| | | | | Number | | | Polycarbonate | | | Hydroxyl |
| | | | | of | (Meth)acryloyl | | diol (a1) and its | | | group- |
| | | | Compound | functional | group content | | composition | | Diisocyanate | containing |
| | | | name | groups | [mol/g] | Mn | (molar ratio) | | (a2) | acrylate (a3) |
| Synthesis | Urethane | Branched | Urethane | 2 | 0.00075 | 2700 | C-2050 | 3MPD/ | IPDI | HEA |
| Example 1 | resin (A) | | acrylate A1 | | | | | C6 = 50/50 | | |
| Synthesis | | | Urethane | 2 | 0.00075 | 2700 | C-2090 | 3MPD/ | IPDI | HEA |
| Example 2 | | | acrylate A2 | | | | | C6 = 90/10 | | |
| Synthesis | | | Urethane | 2 | 0.00052 | 3900 | C-3050 | 3MPD/ | IPDI | HEA |
| Example 3 | | | acrylate A3 | | | | | C6 = 50/50 | | |
| Synthesis | | | Urethane | 2 | 0.00054 | 3700 | C-3090 | 3MPD/ | IPDI | HEA |
| Example 4 | | | acrylate A4 | | | | | C6 = 90/10 | | |
| Synthesis | | | Urethane | 2 | 0.00073 | 2700 | C- | C9/MOD = | IPDI | HEA |
| Example 5 | | | acrylate A5 | | | | 2015N | 15/85 | | |
| Synthesis | | | Urethane | 2 | 0.00074 | 2700 | C- | C9/MOD = | IPDI | HEA |
| Example 6 | | | acrylate A6 | | | | 2065N | 35/65 | | |
| Synthesis | | Low | Urethane | 2 | 0.00117 | 1700 | C-1090 | 3MPD/ | IPDI | HEA |
| Example 8 | | molecular | acrylate B1 | | | | | C6 = 90/10 | | |
| | | weight | | | | | | | | |
| Synthesis | | Linear | Urethane | 2 | 0.00132 | 1500 | G3450J | C3/C4 = | IPDI | HEA |
| Example 9 | | | acrylate B2 | | | | | 50/50 | | |
| Synthesis | | | Urethane | 2 | 0.00071 | 2800 | G3452 | C3/C4 = | IPDI | HEA |
| Example 7 | | | acrylate A7 | | | | | 50/50 | | |
| Synthesis | | | Urethane | 2 | 0.00119 | 1700 | T5651 | C5/C6 = | IPDI | HEA |
| Example 10 | | | acrylate B3 | | | | | 50/50 | | |

| | | | | | | | | | |
|---|---|---|---|---|---|---|---|---|---|
| Synthesis | Urethane resins | Urethane | 3 | 0.00131 | 2300 | — | — | HDI nurate*¹ | ε-Lactone- |
| Example 11 | other than the above | acrylate B4 | | | | | | | modified HEA |

*¹Polyisocyanate

### Example 1: Preparation of Curable Resin Composition (M1)

A four-neck flask equipped with a stirrer, a thermometer, and a cooling tube was charged with 25 parts by mass of the urethane (meth)acrylate (A1) obtained in Synthesis Example 1, 75 parts by mass of IBXA available from Osaka Organic Chemical Industry Ltd., and 2 parts by mass of Omnirad-TPO available from BASF, followed by stirring at 60° C. or lower until uniform dissolution was achieved, to obtain a curable resin composition (M1).

### Examples 2 to 14: Preparation of Curable Resin Compositions (M2) to (M14) for Stereolithography

Curable resin compositions (M2) to (M14) for stereolithography were obtained in the same manner as in Example 1, except that the compositions and the blending amounts of the urethane resin (A), the compound (B), and the compound (C) were changed to those shown in Table 1 or Table 2.

### Comparative Examples 1 to 7: Preparation of Curable Resin Compositions (cM1) to (cM7) for Stereolithography

Curable resin compositions (cM1) to (cM7) for stereolithography were obtained in the same manner as in Example 1, except that the compositions and the blending amounts of the urethane resin (A), the compound (B), and the compound (C) were changed to those shown in Table 2.

The following evaluations were performed using the curable resin compositions for stereolithography obtained in Examples 1 to 14 and Comparative Examples 1 to 7.

### Measurement of Viscosity

The viscosity at 25° C. of the curable resin composition obtained in each of the examples and the comparative examples was measured using an E-type viscometer (“TV-22” available from Toki Sangyo Co., Ltd.).

### Fabrication of Test Piece

A test piece for a deflection temperature under load test and a test piece for an Izod impact test (in accordance with ASTM D256, breadth: 3.2 mm) were fabricated using a stereolithography 3D printer (“Vittro P100” available from 3D Light). The stereolithography was performed at an illumination of 2.5 mW/cm² per layer, for an irradiation time of 10 seconds, and at a pitch of 100 μm in the z-axis (height direction). Next, the test piece for a deflection temperature under load test and the test piece for an Izod impact test obtained by the stereolithography were washed with isopropyl alcohol, dried at ambient temperature for 1 hour, and then irradiated with light from an LED having a wavelength of 385 nm for 10 minutes on each surface using Multicure 180 available from XYZ Printing Inc. as post-curing to obtain a test piece 1 (test piece for a deflection temperature under load test) and a test piece 2 (test piece for an Izod impact test).

### Method for Measuring Deflection Temperature Under Load (Heat Resistance)

In accordance with ASTM D648, a deflection temperature under load test (HDT) was performed using the test piece 1 by “HDT Testing Apparatus (Model: 6M-2)” available from Toyo Seiki Seisaku-sho, Ltd.

Method for Measuring Izod Impact Strength (Impact Resistance) In accordance with ASTM D256, the Izod impact strength of the test piece 2 was measured using “Izod Impact Tester” available from Toyo Seiki Seisaku-sho, Ltd. and a hammer of 1.0 J.

The compositions and evaluation results of the curable resin compositions obtained in Examples 1 to 14 and Comparative Examples 1 to 7 are shown in Table 2 below.

TABLE 2

| | | | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|---|---|---|---|---|---|---|---|---|
| | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | | [symbol] | [symbol] | [symbol] | | | | | | | | | | | | | [symbol] | | | | | |
| [symbol] | | [symbol] | | | | | [symbol] | | | | | | | | [symbol] | | | | | | | | | |
| | | [symbol] | | | | | | [symbol] | | | | | | | | | | | | | | | | |
| | | [symbol] | | | | | | | [symbol] | [symbol] | [symbol] | | | | | [symbol] | [symbol] | | | [symbol] | | | | |
| | | [symbol] | | | | | | | | | | [symbol] | | | | | | | | | | | | |
| | | [symbol] | | | | | | | | | | | [symbol] | | | | | | | | | | | |
| | [symbol] | [symbol] | | | | | | | | | | | | | | | | | | | | [symbol] | | |
| | [symbol] | [symbol] | | | | | | | | | | | | | | | | | | | | | [symbol] | |
| | | [symbol] | | | | | | | | | | | | [symbol] | | | | | | | | | | |
| | | [symbol] | | | | | | | | | | | | | | | | | | | | | | [symbol] |
| [symbol] | | [symbol] | | | | | | | | | | | | | | | | | | | [symbol] | | | |
| [symbol] | | [symbol] | [symbol] | | | [symbol] | [symbol] | [symbol] | [symbol] | | [symbol] | [symbol] | [symbol] | [symbol] | [symbol] | [symbol] | [symbol] | [symbol] | | | [symbol] | [symbol] | [symbol] | [symbol] |
| | | [symbol] | [symbol] | [symbol] | | | | | | | | | | | | | | | | | | | | |
| | | [symbol] | [symbol] | | [symbol] | | | | | | | | | | | | | | | | | | | |
| | | [symbol] | [symbol] | | | | | | | [symbol] | | | | | | | | | | | | | | |
| [symbol] | | [symbol] | [symbol] | | | | | | | | | | | | | | | | [symbol] | | | | | |
| [symbol] | | [symbol] | [symbol] | | | [symbol] | [symbol] | [symbol] | [symbol] | [symbol] | [symbol] | [symbol] | [symbol] | [symbol] | | | | [symbol] | [symbol] | [symbol] | [symbol] | [symbol] | [symbol] | [symbol] |
| | | [symbol] | [symbol] | | | | | | | | | | | | | | [symbol] | | | | | | | |
| | | [symbol] | [symbol] | | | | | | | | [symbol] | | | | | | | | | | | | | |
| | | [symbol] | [symbol] | | | | | | | | | | | | [symbol] | | | | | | | | | |
| | | [symbol] | [symbol] | | | | | | | | | | | | | [symbol] | | | | | | | | |
| [symbol] | | [symbol] | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | | | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

(Discussion) The viscosity of the curable resin composition is 15000 mPa·s or less, preferably 10000 mPa·s or less, from the viewpoint of the shapeability and the load on the shaping machine. In addition, the deflection temperature under load of the shaped object needs to be 45° C. or higher from the viewpoint of heat resistance, and the higher the deflection temperature under load, the better the heat resistance. From the viewpoint of impact resistance, the Izod impact strength needs to be 45 J/m or more, and the higher the Izod impact strength, the better the impact resistance.

It is found that, in the compositions of Examples 1 and 2 in which the urethane resin (A) and the α,β-unsaturated carbonyl compound (B) are blended, heat resistance can be secured with high impact resistance. In addition, it is found that, also in the compositions of Examples 3 to 14 in which the compound (C) having two or more (meth)acryloyl groups is further blended, both high heat resistance and high impact resistance are achieved. Further, from the comparison between Example 4 and Comparative Example 5 and between Example 11 and Comparative Example 7, it is also found that as the molecular weight of the polycarbonate diol as a raw material of the urethane resin is larger, higher impact resistance can be imparted while heat resistance is maintained. From the results of Table 2, it could be confirmed that the curable resin composition of the present embodiments can form an optical three-dimensional shaped object having both sufficient toughness and heat resistance. The curable resin composition of the present embodiments can be effectively used for stereolithography.

1. A curable resin composition for stereolithography, comprising:
a urethane resin (A) having two (meth)acryloyl groups;
an α,β-unsaturated carbonyl compound (B); and
a photopolymerization initiator wherein,
the urethane resin (A) is obtained by using, as reaction raw materials, a polycarbonate diol (a1), a diisocyanate (a2), and a compound (a3) having a hydroxyl group and a (meth)acryloyl group,
the polycarbonate diol (a1) has a branched or linear aliphatic structure,
the α,β-unsaturated carbonyl compound (B) has a glass transition temperature (Tg) of 50° C. or higher when formed into a polymer, and
the urethane resin (A) has a number average molecular weight (Mn) of 2000 or more.

2. The curable resin composition for stereolithography according to claim 1, further comprising a compound (C) having two or more (meth)acryloyl groups wherein,
the compound (C) having two or more (meth)acryloyl groups has a glass transition temperature (Tg) of 60° C. or higher when formed into a polymer.

3. The curable resin composition for stereolithography according to claim 1, wherein the α,β-unsaturated carbonyl compound (B) is a compound having one (meth)acryloyl group.

4. The curable resin composition for stereolithography according to claim 1, wherein a content of the (meth)acryloyl groups in the urethane resin (A) is 0.3 mmol/g or more and 2.0 mmol/g or less.

5. The curable resin composition for stereolithography according to claim 1, wherein a content of the urethane resin (A) is 1 mass % or more and 50 mass % or less.

6. The curable resin composition for stereolithography according to claim 1, wherein a content of the α,β-unsaturated carbonyl compound (B) is 20 mass % or more and 90 mass % or less.

7. The curable resin composition for stereolithography according to claim 2, wherein a content of the compound (C) having two or more (meth)acryloyl groups, when the compound (C) is contained, is 1 mass % or more and 50 mass % or less.

8. The curable resin composition for stereolithography according to claim 1, wherein the urethane resin (A) is a resin represented by Formula (1) described below: 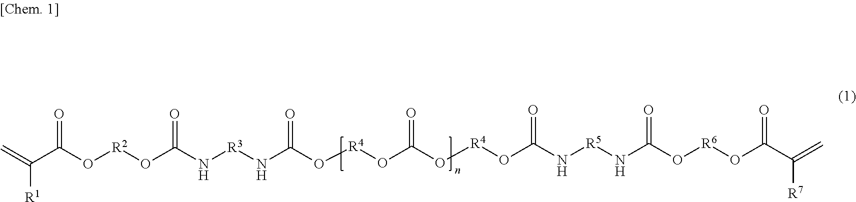
(In Formula (1),
R¹ and R⁷ each independently represent a hydrogen atom or a methyl group,
R² and R⁶ each independently represent —C₂H₄—, —C₃H₆—, —C₄H₈—, or —C₂H₄O(COC₅H₁₀)ₛ— (s=from 1 to 4),
R³ and R⁵ each independently represent —C₅H₁₀—, —C₆H₁₂—, —C₁₀H₁₈—, or —C₉H₁₈—,
R⁴ represents one or two or more divalent groups selected from the group consisting of —(CH₂)ₛ— (s=from 2 to 12) and —(CH₂)ₛ—CH(CH₃)—(CH₂)ₜ— (s and t are optionally 0, and s+t=from 0 to 10), and
n represents an integer of from 2 to 100.

9. A cured product which is a cured reaction product of the curable resin composition for stereolithography described in claim 1.

10. A three-dimensional shaped object comprising the cured product described in claim 9.
